(19) United States
(12) Patent Application Publication
(10) Pub. No.: US 2015/0160395 A1
(43) Pub. Date: Jun. 11, 2015

(54) LIGHT GUIDE WITH LIGHT INPUT FEATURES

(71) Applicant: Rambus Delaware LLC, Brecksville, OH (US)

(72) Inventors: Dane A. Sahlhoff, Strongsville, OH (US); Timothy A. McCollum, Avon Lake, OH (US)

(21) Appl. No.: 14/535,825

(22) Filed: Nov. 7, 2014

Related U.S. Application Data
(60) Provisional application No. 61/912,607, filed on Dec. 6, 2013.

(51) Int. Cl. F21V 8/00

(52) U.S. Cl. CPC G02B 6/002

(57) ABSTRACT

A light guide includes opposed major surfaces between which light propagates by total internal reflection, and an edge extending between the major surfaces of the light guide and extending in a lateral direction orthogonal to the thickness direction. The edge includes light input features. Each light input feature includes a light input region through which light is input into the light guide and a reflector to internally reflect light incident thereon from the light input region. The reflector includes reflective microstructures that cause the reflected light to propagate in the light guide as if originating from virtual light sources at locations laterally offset from the light input region.

### RELATED APPLICATION DATA

This application claims the benefit of U.S. Provisional Patent Application No. 61/912,607, filed Dec. 6, 2013, the disclosure of which is herein incorporated by reference in its entirety.

### BACKGROUND

Light emitting diodes (LEDs) show promise as an energy efficient light source for lighting assemblies. For some LED-based lighting assemblies, the light emitted from the light source is input to a light guide and light extracting elements specularly extract the light from the light guide in a defined direction. But the light extracting elements also provide an optically-specular path through the light guide and along which the light source is visible to a viewer. Reducing the visibility of the light source while maintaining the directional, specular light output is desirable in many applications.

### BRIEF DESCRIPTION OF THE DRAWINGS

FIG. 1 is a schematic perspective view of an exemplary lighting assembly.

FIG. 2 is a schematic view of an exemplary light input feature.

FIG. 3 is a schematic view of an exemplary light input region.

FIG. 4 is a schematic view of an exemplary reflective microstructure.

FIG. 5 is a schematic view of an exemplary light input feature.

FIG. 6 is a schematic view of an exemplary lighting assembly.

FIG. 7 is a schematic view of an exemplary light input feature.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface.

A light guide includes opposed major surfaces between which light propagates by total internal reflection, and an edge extending between the major surfaces in a thickness direction and extending in a lateral direction orthogonal to the thickness direction. The edge includes light input features. Each light input feature includes a light input region through which light is input into the light guide and a reflector to internally reflect light incident thereon from the light input region. The reflector includes reflective microstructures that cause the reflected light to propagate in the light guide as if originating from virtual light sources at locations laterally offset from the light input region.

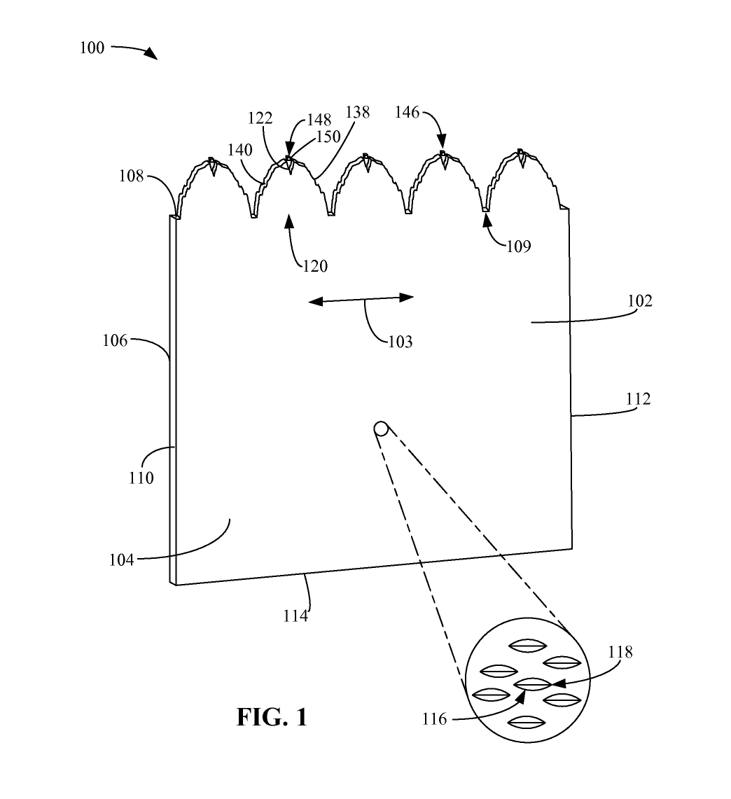

With initial reference to FIG. 1, an exemplary lighting assembly is shown at 100. The lighting assembly 100 includes a light guide 102. The light guide 102 is a solid article of manufacture made from, for example, polycarbonate, poly(methyl-methacrylate) (PMMA), glass, or other appropriate material. The light guide 102 may also be a multi-layer light guide having two or more layers that may differ in refractive index. The light guide 102 includes a first major surface 104 and a second major surface 106 opposite the first major surface 104. The light guide 102 is configured to propagate light by total internal reflection between the first major surface 104 and the second major surface 106. The length and width dimensions of each of the major surfaces 104, 106 are greater, typically ten or more times greater, than the thickness of the light guide 102. The thickness is the dimension of the light guide 102 in a direction orthogonal to the major surfaces 104, 106.

At least one edge extends between the major surfaces 104, 106 of the light guide in the thickness direction. The total number of edges depends on the configuration of the light guide. In the case where the light guide is generally rectangular in shape, the light guide has four edges 108, 110, 112, 114. Other light guide shapes result in a corresponding number of edges. Exemplary shapes of the light guide include a circle or oval, a triangle, a regular or irregular polygon, a dome, a hollow cylinder, a hollow cone or pyramid, a hollow frustrated cone or pyramid, a bell shape, an hourglass shape, or another suitable shape. Depending on the shape of the light guide 102, each edge may be straight or curved, and adjacent edges may meet at a vertex or join in a curve. Moreover, each edge may include one or more straight portions connected to one or more curved portions.

In the illustrated embodiment, the major surfaces 104, 106 are planar. In other embodiments, at least a portion of the major surfaces 104, 106 of the light guide 102 is curved in one or more directions. In one example, the intersection of the edge 108 and one of the major surfaces 104, 106 defines a first axis, and at least a portion of the light guide 102 curves about an axis orthogonal to the first axis. In another example, at least a portion of the light guide 102 curves about an axis parallel to the first axis.

The length and width dimensions of each of the major surfaces 104, 106 are much greater, typically ten or more times greater, than the thickness of the light guide 102. The thickness of the light guide 102 may be, for example, about 0.1 millimeters (mm) to about 10 mm.

The light guide 102 includes light extracting elements 116 embodied as micro-optical elements 118 in, on, or beneath at least one of the major surfaces 104, 106. The reference numeral 116 will be generally used to collectively refer to the different embodiments of light extracting elements. Micro-optical elements 118 that are in, on, or beneath a major surface will be referred to as being “at” the major surface. A micro-optical element 118 of well-defined shape is a three-dimensional feature recessed into a major surface and/or protruding from a major surface having distinct surfaces on a scale larger than the surface roughness of the surfaces. Micro-optical elements 118 of well-defined shape exclude features of indistinct shape or surface textures, such as printed features of indistinct shape, inkjet printed features of indistinct shape, selectively-deposited features of indistinct shape, and features of indistinct shape wholly formed by chemical etching or laser etching.

Each micro-optical element 118 functions to disrupt the total internal reflection of the light propagating in the light guide 102 and incident thereon. In one embodiment, the micro-optical elements 118 reflect light toward the opposing major surface so that the light exits the light guide 102 through the opposing major surface. Alternatively, the micro-optical elements 118 transmit light through the micro-optical elements 118 and out of the major surface of the light guide 102 having the micro-optical elements 118. In another embodiment, both types of micro-optical elements 118 are present. In yet another embodiment, the micro-optical elements 118 reflect some of the light and refract the remainder of the light incident thereon. Therefore, the micro-optical elements 118 are configured to extract light from the light guide 102 through one or both of the major surfaces 104, 106.

Micro-optical elements 118 are small relative to the linear dimensions of the major surfaces 104, 106. The smaller of the length and width of a micro-optical element 118 is less than one-tenth of the longer of the length and width (or circumference) of the light guide 102 and the larger of the length and width of the micro-optical element 118 is less than one-half of the smaller of the length and width (or circumference) of the light guide 102. The length and width of the micro-optical element 118 is measured in a plane parallel to the major surface 104, 106 of the light guide 102 for planar light guides or along a surface contour for non-planar light guides 102.

The micro-optical elements 118 are configured to extract light in a defined intensity profile (e.g., a uniform intensity profile) and in a defined light ray angle distribution from one or both of the major surfaces 104, 106. In this disclosure, intensity profile refers to the variation of intensity with position within a light-emitting region (such as the major surface or a light output region of the major surface). The term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface.

Micro-optical elements 118 are shaped to predictably reflect light or predictably refract light. However, one or more of the surfaces of the micro-optical elements may be modified, such as roughened, to produce a secondary effect on light output. Exemplary micro-optical elements are described in U.S. Pat. No. 6,752,505 and, for the sake of brevity, are not described in detail in this disclosure. The micro-optical elements may vary in one or more of size, shape, depth or height, density, orientation, slope angle, or index of refraction such that a desired light output from the light guide 102 is achieved over the corresponding major surface 104, 106

Although not specifically shown, the light guide 102 may additionally include light extracting elements 116 embodied as light-scattering elements, which are typically features of indistinct shape or surface texture, such as printed features of indistinct shape, ink-jet printed features of indistinct shape, selectively-deposited features of indistinct shape, and features of indistinct shape wholly formed by chemical etching or laser etching.

Light guides having light-extracting elements 116 are typically formed by a process such as injection molding. The light-extracting elements 116 are typically defined in a shim or insert used for injection molding light guides by a process such as diamond machining, laser etching, laser micromachining, chemical etching, or photolithography. Alternatively, any of the above-mentioned processes may be used to define the light-extracting elements 116 in a master that is used to make the shim or insert. In other embodiments, light guides without light-extracting elements 116 are typically formed by a process such as injection molding or extruding, and the light-extracting elements 116 are subsequently formed on one or both of the major surfaces 104, 106 by a process such as stamping, embossing, laser etching, or another suitable process. Light-extracting elements 116 may also be produced by depositing elements of curable material on the major surfaces 104, 106 of the light guide 102 and curing the deposited material using heat, UV light, or other radiation. The curable material can be deposited by a process such as printing, ink jet printing, screen printing, or another suitable process. Alternatively, the light-extracting elements 116 may be inside the light guide between the major surfaces 104, 106 (e.g., the light-extracting elements 116 may be light redirecting particles and/or voids disposed within the light guide).

The lighting assembly 100 additionally includes a light source assembly 146. The light source assembly 146 includes light sources 148. Light is input to the light guide 102 from the light source 148 through one or more light input regions located along one or more of the edges of the light guide. In the embodiment shown in FIG. 1, light input regions 122 are located along edge 108. The edge 108 extends in a lateral direction 103 orthogonal to the thickness direction, and the respective light input regions 122 and light sources 148 are laterally spaced from one another. The light input regions are described in more detail below.

Each light source 148 is embodied as one or more solid-state light emitters 150. Exemplary solid-state light emitters 150 include such devices as LEDs, laser diodes, and organic LEDs (OLEDs). In an embodiment where the solid-state light emitters 118 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, the solid-state light emitters 150 emit light with no operably-effective intensity at wavelengths greater than 500 nanometers (nm) (i.e., the solid-state light emitters 150 emit light at wavelengths that are predominantly less than 500 nm). In some embodiments, the solid-state light emitters 150 constituting light source assembly 146 all generate light having the same nominal spectrum. In other embodiments, at least some of the solid-state light emitters 150 constituting light source assembly 146 generate light that differs in spectrum from the light generated by the remaining solid-state light emitters 150. For example, two different types of solid-state light emitters 150 are alternately located along the light source assembly 146.

Although not illustrated in detail, the light source assembly 146 also includes structural components to retain the light sources 148. In one embodiment, the light sources 148 are mounted to a printed circuit board (PCB). The lighting assembly 100 may additionally include a housing for retaining the light source assembly 146 and the light guide 102. The housing may retain a heat sink or may itself function as a heat sink.

Light guides including light extracting elements 116 (e.g., micro-optical elements 118) that specularly extract the light from the light guide 102 in a defined direction also include an optically-specular path extending from the light extracting element 116 back to the edge 108 of the light guide 102. Reflections of the light source 148 as viewed through the optically-specular path are visible to a viewer viewing the lighting assembly 100. Therefore, even if the light extracting elements 116 (e.g., micro-optical elements 118) are arranged to extract light in a uniform intensity profile over the major surface 104, 106, since the array of light sources 148 is not a uniform (contiguous) light source along the edge 108, the optically-specular path creates the visual effect of one or more relatively high-intensity columns of light extending along the light guide 102 from the edge 108. This visual effect is also referred to herein as a “headlighting” effect.

While the headlighting effect can be reduced by one or more optical adjusters (e.g., a diffuser film) located adjacent one or both of the major surfaces 104, 106, the use of the optical adjusters for such purpose destroys the directional, specular light output distribution of the light output from the lighting assembly 100. Furthermore, in many applications, the use of an optical adjuster is not preferable (e.g., for aesthetic reasons).

In accordance with the present disclosure, and with exemplary reference to FIGS. 1-4, the light guide includes light input features 120 at the edge 108. The light input features 120 cause the light input to the light guide 102 by the light source 148 to propagate in the light guide 102 as if originating from laterally offset virtual light sources. The light input features 120 reduce or eliminate the headlighting effect by providing the visual effect of nominally uniform light input proximate the edge 108 to a viewer viewing the lighting assembly 100.

FIG. 1 shows an exemplary embodiment in which multiple light input features 120 are arranged along the edge 108. Any suitable number of light input features 120 may be included along the edge 108. The number of light input features 120 may depend on such factors as the size and shape of the light guide 102, the size of the light input features 120, the spacing between respective light input features 120, etc.

The light input features 120 shown in FIG. 1 are spaced apart from one another by a distance 109. In some embodiments, the distances 109 between the respective light input features 120 are the same. In other embodiments, the distances 109 between at least some of the respective light input features 120 vary. Preferably, at least some of the adjacent light input features 120 abut one another such that the distance 109 is non-existent.

The edge 108 defines the shape of the light input features 120. In some embodiments, the light input features 120 are formed with the light guide 102 during manufacture of the light guide 102 (e.g., the light input features 120 may be formed by an injection molding process that also forms the light guide 102). In other embodiments, the light input features 120 are optically bonded to the light guide 102 (e.g., using an index matching material such as an adhesive).

Each light input feature 120 includes a light input region 122 through which light from the light source 148 is input into the light guide 102. The light input region includes one or more redirecting features configured to laterally redirect light incident on the light input region.

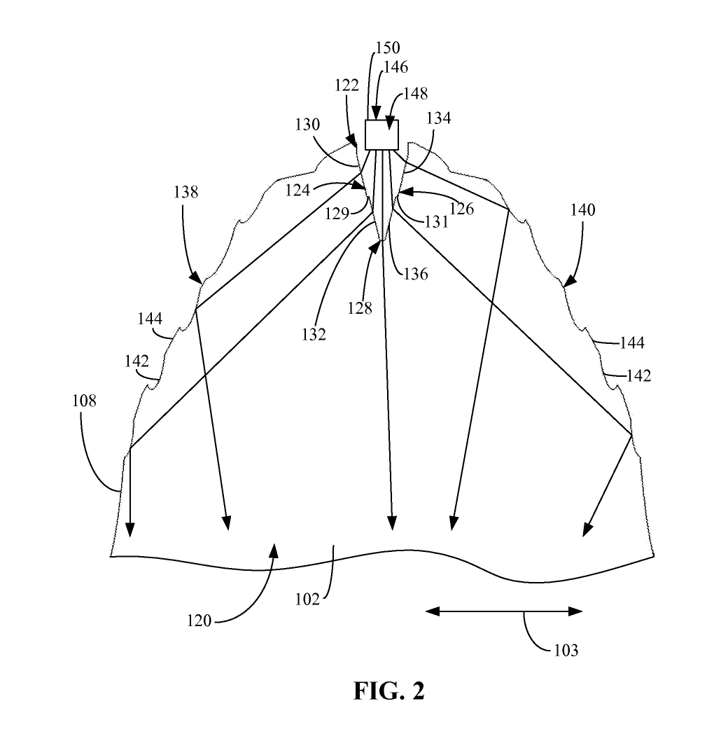

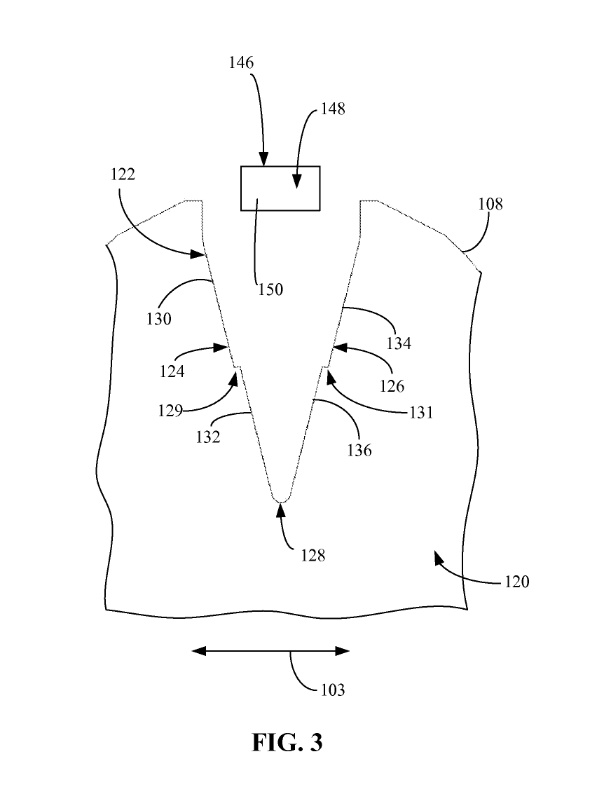

In some embodiments, the light input region 122 is a multi-faceted surface configured to modify the light ray angle distribution of the light input to the light guide. With specific reference to FIGS. 2 and 3, the light input region 122 includes a first light input segment 124 and a second light input segment 126 non-parallel to the first light input segment 124. The first light input segment 124 and the second light input segment 126 are orthogonal to the major surfaces 104, 106, and converge at a convergence region 128 centered on the light source 148. Each of the first light input segment 124 and the second light input segment 126 includes a stepped surface 129, 131. The first light input segment includes a first portion 130 and a second portion 132. The second light input segment 126 includes a first portion 134 and a second portion 136. In other embodiments, the first light input segment 124 and the second light input segment 126 do not include a stepped surface.

In other embodiments, light input region 122 includes other suitable configurations for modifying the light ray angle distribution of the light input to the light guide 102 therethrough. In some examples, the light input region 122 includes V-grooves oriented orthogonally to major surfaces 104, 106. In other examples (not shown), the light input region 122 includes non-planar surfaces such as lenticular grooves oriented orthogonally to major surfaces 104, 106. In still other examples (not shown), the light input region includes micro-optical elements.

Each light input feature 120 additionally includes at least one reflector to internally reflect light incident thereon from the light input region 122. As shown in FIGS. 1 and 2, each of the light input features 120 includes a first reflector 138 adjacent the light input region 122 and a second reflector 140 adjacent the light input region 122 and opposite the first reflector 138. The first reflector 138 is adjacent the first light input segment 124, and the second reflector 140 is adjacent the second light input segment 126. The overall shape of the reflectors 138, 140 is arcuate (e.g., substantially parabolic). In other embodiments, the overall shape of the first and second reflectors 138, 140 is substantially trapezoidal or substantially triangular.

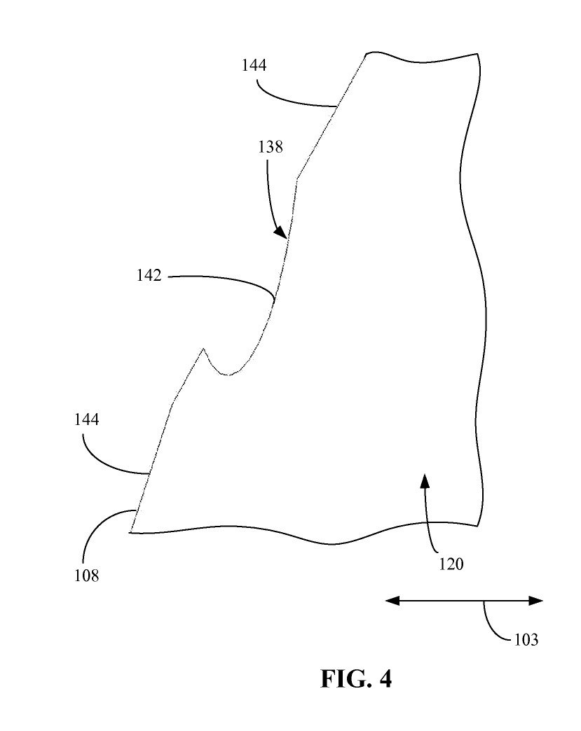

The surface of the first and second reflectors 138, 140 include surface features that follow the overall shape, but introduce non-uniformity thereto. With specific reference to FIGS. 2 and 4, the first and second reflectors 138, 140 each include reflective microstructures 142. Each reflective microstructure 142 is an indentation into the light input feature 120. As described below, the reflective microstructures 142 cause the reflected light to propagate in the light guide 102 as if originating from virtual light sources at locations laterally offset from the light input region 122. Additionally, the stepped surfaces 129, 131 and the convergence region 128 transmit light into the light guide 102 as if the light originates from virtual light sources at the lateral locations of the stepped surfaces 129, 131 and the convergence region 128, respectively. The reflective microstructures 142 are separated from one another by non-indented surface features 144. As shown in FIG. 2, a non-indented surface feature 144 is arranged between adjacent reflective microstructures 142. In the example shown, the non-indented surface feature 144 is planar. In other embodiments, the non-indented surface feature 144 follows the contour of the arcuate (e.g., parabolic) shape of the reflector.

As described above, the reflective microstructures 142 are configured to internally reflect the light input from the light input surface 122 and incident on the reflective microstructures 142. However, in some embodiments, a reflective material (not shown) is included at the surface of the reflective microstructures 142.

A first portion of the light input to the light guide 102 through the light input region 122 is input through the first light input segment 124, a second portion of the light input to the light guide 102 though the light input region 122 is input through the second light input segment 126, and the remainder of the light input to the light guide 102 through the light input region 122 is input through the convergence region 128 and the stepped surfaces 129, 131. The majority of the light input to the light guide 102 is input through one of the first input region 122 and the second input region 124, and the majority of the light input to the light guide 102 is redirected toward the reflectors 138, 140. Only a small portion of light emitted from the light source 148 is input to the light input region (e.g., through the convergence region 128 and the stepped surfaces 129, 131) and is not redirected toward one of the reflectors 138, 140.

The first portion of the light input to the light guide 102 is incident on the first reflector 138, and the second portion of the light input to the light guide 102 is incident on the second reflector 140. The first and second portions of the light are incident on the reflective microstructures 142, respectively, and the light is reflected so as to propagate in a direction toward the distal edge 114 of the light guide 102.

The light input region 122 and the reflectors 138, 140 are configured such that approximately the same flux is incident on each reflective microstructure 142. Accordingly, the virtual light sources are approximately the same in intensity. In one example, the difference in intensity between any two of the virtual light sources is no more than about 10%. In another example, the difference in intensity between any two of the virtual light sources is no more than about 15%. In yet another example, the difference in intensity between any two of the virtual light sources is no more than about 20%. In some embodiments, the intensity of the virtual light sources is also approximately equal to the intensity of on-axis light input to the light guide 102 through the convergence region 128 and the stepped surfaces 129, 131. In one example, the difference in intensity between a virtual light source and the on-axis light is no more than about 10%. In another embodiment, the difference in intensity between a virtual light source and the on-axis light is no more than about 15%. In yet another embodiment, the difference in intensity between a virtual light source and the on-axis light is no more than about 20%.

The respective intensities of the virtual light sources and of the on-axis light may depend on the geometry of the light input region 122 (e.g., the relative angles of the light input segments 124, 126, the shape and/or size of the convergence region 128 and the stepped surfaces 129, 131, etc.), as well as the geometry of the reflectors (e.g., curvature of the reflectors 138, 140, the relative size and/or curvature of the reflective microstructures 142, etc.)

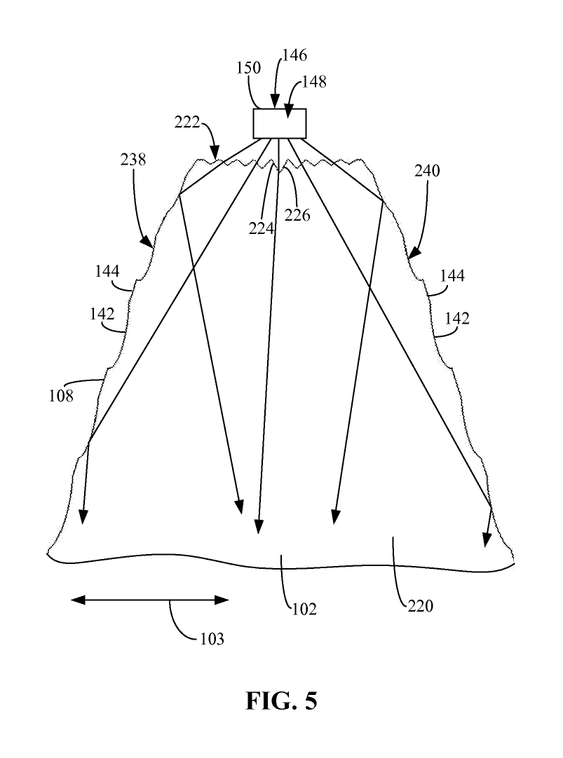

Referring now to FIG. 5, another exemplary embodiment of the light input feature is shown at 220. The light input feature 220 is similar to the light input feature shown in FIGS. 1-4. But the light input region 222 of the light input feature 220 is embodied as a multi-faceted surface including multiple instances of the first light input segment 224 and multiple instances of the second light input segment 226. Respective first light input segments 224 and second light input segments 226 form V-grooves oriented orthogonally to the major surfaces. The size and shape of the V-grooves vary with respect to the lateral position along the edge 108. As shown, the included angle between the respective first and second light input segments 224, 226 increases with increasing distance from the midpoint between the first and second reflectors 238, 240.

The light input feature 220 includes first and second reflectors 238, 240 adjacent the light input region and opposite one another. The first and second reflectors 238, 240 are similar to the first and second reflectors 138, 140 in that they each include reflective microstructures 142 separated from one another by non-indented surface features 144. But the overall shape of the first and second reflectors 238, 240 differs from the overall shape of the first and second reflectors 138, 140. With specific reference to FIG. 5, the overall shape of the light input region 222 and the first and second reflectors 238, 240 is substantially trapezoidal.

Each first light input segment 224 redirects the light emitted from the light source 148 and incident thereon towards first reflector 238, and each second light input segment 226 redirects the light emitted from the light source 148 and incident thereon towards second reflector 240. The majority of the light input to the light guide 102 through the light input region 222 is redirected toward the reflectors 238, 240.

The first portion of the light input to the light guide 102 is incident on the first reflector 238, and the second portion of the light input to the light guide 102 is incident on the second reflector 240. The first and second portions of the light are incident on the reflective microstructures 142, respectively, and the light is reflected so as to propagate in a direction toward the distal edge of the light guide 102.

The light input region 222 and the reflectors 238, 240 are configured such that approximately the same flux is incident on each reflective microstructure 142. Accordingly, the virtual light sources are approximately the same in intensity. In one example, the difference in intensity between any two of the virtual light sources is no more than about 10%. In another example, the difference in intensity between any two of the virtual light sources is no more than about 15%. In yet another example, the difference in intensity between any two of the virtual light sources is no more than about 20%.

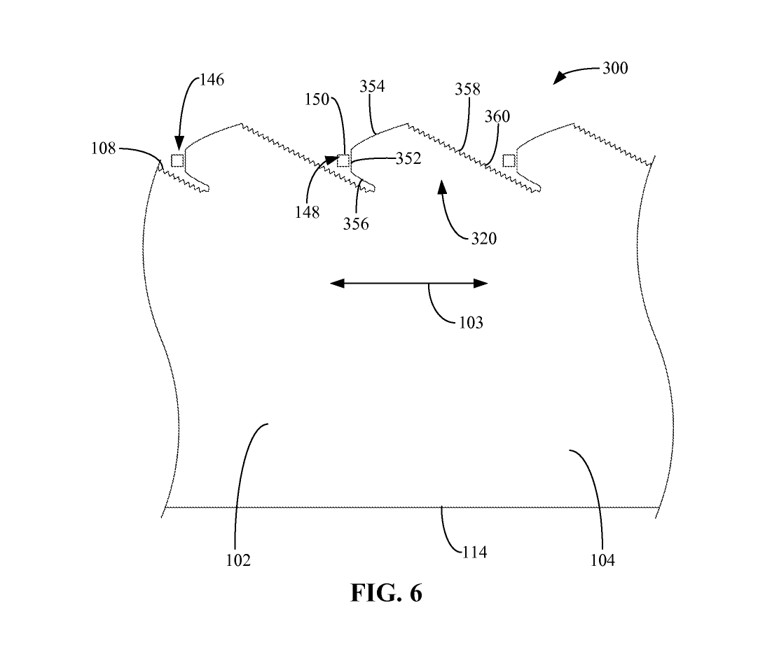

Referring now to FIG. 6, another exemplary embodiment of the lighting assembly is shown at 300. The lighting assembly 300 is similar to the lighting assembly 100. But the light input region 352 of each light input feature 320 extends in a direction transverse to the lateral direction 103 such that the light is laterally input to the light guide 102. Similar to the light input features 120, 220, the light input features 320 cause the light input to the light guide 102 by the light source 148 to propagate in the light guide 102 as if originating from laterally offset virtual light sources.

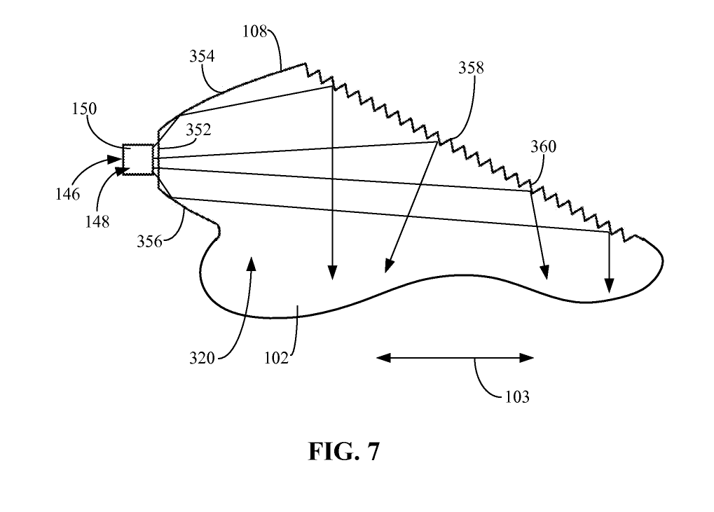

With additional reference to FIG. 7, each light input feature 320 includes a light input region 352 through which light from the light source 148 is input into the light guide 102. The light input region 352 extends in a direction transverse the lateral direction 103. In the embodiment shown, the light input region 352 is a planar surface. In other embodiments, the light input region 352 includes one or more redirecting features configured to redirect light incident on the light input region. In some examples (not shown), the light input region 352 includes V-grooves oriented orthogonally to the major surfaces 104, 106 (not shown). In other examples (not shown), the light input region 352 includes non-planar surfaces such as lenticular grooves oriented orthogonally to the major surfaces 104, 106 (not shown). In still other examples (not shown), the light input region 352 includes micro-optical elements.

Each light input feature 320 additionally includes at least one concentrator surface adjacent the light input region 352. As shown in FIGS. 6 and 7, each of the light input features 320 includes a first concentrator surface 354 adjacent the light input region 352 and a second concentrator surface 356 adjacent the light input region 352 and opposite the first concentrator surface 354. The overall shape of the concentrator surfaces 354, 356 is arcuate. In other embodiments, the first and second concentrator surfaces 354, 356 are non-planar surfaces with linear segments. Each concentrator surface reflects light input to the light guide through the light input region and incident thereon towards the reflector with a light ray angle distribution narrower than the light transmitted through the light input surface.

The respective surfaces of the first and second concentrator surfaces 354, 356 are devoid of surface features (e.g., the first and second concentrator surfaces 354, 356 are specularly-reflective surfaces). In other embodiments, the surface of the first and second concentrator surfaces 354, 356 include surface features.

Each concentrator surface reflects a portion of the light input to the light guide through the light input region towards the reflector. The concentrator surfaces 354, 356 are configured to internally reflect the light input from the light input surface 352 and incident on the concentrator surfaces 354, 356. However, in some embodiments, a reflective material (not shown) is included at the surface of the concentrator surfaces 354, 356.

Each light input feature 320 additionally includes a reflector 358 opposite the light input region 352 and extending in a direction oblique to the light input region and oblique to the lateral direction 103. The surface of the reflector 358 includes reflective microstructures 360 configured to reflect light input to the light guide 102 through the light input region and incident thereon in a direction nominally transverse to the lateral direction 103. In the embodiment shown in FIGS. 6 and 7, each reflective microstructure 360 is an indentation into the light input feature 320. The reflective microstructures are embodied as stepped, planar surfaces. In other embodiments, the reflective microstructures are embodied as stepped, non-planar surfaces. Although not specifically shown, in some embodiments, a reflective material is included at the surface of each reflective microstructure 360. The reflective microstructures 360 cause the reflected light to propagate in the light guide as if originating from virtual light sources at locations laterally offset from the light input region.

A first portion of the light input to the light guide 102 through the light input region 352 is incident on the first concentrator element 354, is reflected thereby, and is incident on the reflector 358. A second portion of the light input to the light guide 102 though the light input region 352 is incident on the second concentrator element 356, is reflected thereby, and is incident on the reflector 358. A third portion of the light input to the light guide 102 through the light input region 352 is not incident on either the first or second concentrator element 354, 356 and is incident on the reflector 358. The first, second, and third portions of the light are incident on the reflective microstructures 360, respectively, and the light is reflected so as to propagate in a direction toward the distal edge 114 of the light guide 102. Additionally, a fourth portion of the light input to the light guide 102 through the light input region 352 may not be incident on the reflective microstructures 360.

The light input region 352, the concentrator surfaces 354, 356 and the reflector 358 are configured such that approximately the same flux is incident on each reflective microstructure 360. Accordingly, the virtual light sources are approximately the same in intensity. In one example, the difference in intensity between any two of the virtual light sources is no more than about 10%. In another example, the difference in intensity between any two of the virtual light sources is no more than about 15%. In yet another example, the difference in intensity between any two of the virtual light sources is no more than about 20%.

In this disclosure, the phrase “one of” followed by a list is intended to mean the elements of the list in the alterative. For example, “one of A, B and C” means A or B or C. The phrase “at least one of” followed by a list is intended to mean one or more of the elements of the list in the alterative. For example, “at least one of A, B and C” means A or B or C or (A and B) or (A and C) or (B and C) or (A and B and C).

What is claimed is:

1. A light guide, comprising:
opposed major surfaces between which light propagates by total internal reflection; and
an edge extending between the major surfaces in a thickness direction and extending in a lateral direction orthogonal to the thickness direction, the edge comprising light input features, each light input feature comprising:
a light input region through which light is input into the light guide; and
a reflector to internally reflect light incident thereon from the light input region, the reflector comprising reflective microstructures that cause the reflected light to propagate in the light guide as if originating from virtual light sources at locations laterally offset from the light input region.

2. The light guide of claim 1, wherein the laterally offset virtual light sources are approximately the same in intensity.

3. The light guide of claim 1, wherein the light input region is configured to redirect the light laterally.

4. The light guide of claim 1, wherein each reflective microstructure is an indentation into the light input feature.

5. The light guide of claim 4, wherein the reflector additionally comprises a non-indented surface feature between adjacent reflective microstructures.

6. The light guide of claim 5, wherein the non-indented surface feature comprises a planar surface, or the non-indented surface feature follows the contour of a parabolic shape.

7. The light guide of claim 1, wherein:
the reflector is a first reflector and each of the light input features comprises a second reflector adjacent the light input region and opposite the first reflector; and
the light input region directs a first portion of the light input to the light guide through the light input region towards the first reflector and directs a second portion of the light input to the light guide through the light input region towards the second reflector.

8. The light guide of claim 7, wherein an overall shape of the first and second reflectors is substantially parabolic.

9. The light guide of claim 1, wherein the light input region comprises a first light input segment and a second light input segment non-parallel to the first segment.

10. The light guide of claim 9, wherein each of the first light input segment and the second light input segment comprises a stepped surface.

11. The light guide of claim 1, wherein the light input region comprises a multi-faceted surface.

12. The light guide of claim 1, wherein the light input region comprises v-grooves or lenticular grooves.

13. The light guide of claim 1, wherein the light input region extends in a direction transverse to the lateral direction.

14. The light guide of claim 1, additionally comprising a concentrator surface adjacent the light input region.

15. The light guide of claim 14, wherein the concentrator surface comprises a specularly-reflective surface.

16. The light guide of claim 14, wherein:
the concentrator surface is a first concentrator surface and each of the light input features comprises a second concentrator surface adjacent the light input region and opposite the first concentrator surface; and
the light input region directs a first portion of the light input to the light guide through the light input region towards the first concentrator surface and directs a second portion of the light input to the light guide through the light input region towards the second concentrator surface.

17. The light guide of claim 1, wherein the reflector is opposite the light input region and extends in a direction oblique to the light input region and in a direction oblique to the lateral direction.

18. The light guide of claim 17, wherein each reflective microstructure comprises a stepped, planar surface, or each reflective microstructure comprises a stepped, non-planar surface.

19. A lighting assembly, comprising:
a light guide, comprising:
opposed major surfaces between which light propagates by total internal reflection; and
an edge extending between the major surfaces in a thickness direction and extending in a lateral direction orthogonal to the thickness direction, the edge comprising light input features, each light input feature comprising:
a light input region through which light is input into the light guide; and
a reflector to internally reflect light incident thereon from the light input region, the reflector comprising reflective microstructures that cause the reflected light to propagate in the light guide as if originating from virtual light sources at locations laterally offset from the light input region; and
a respective light source adjacent the light input region of each of the light input features.

20. The lighting assembly of claim 19, wherein each light source comprises a solid-state light emitter.
